(19) United States
(12) Patent Application Publication
(10) Pub. No.: US 2005/0286491 A1
(43) Pub. Date: Dec. 29, 2005

(54) Methods, systems, and computer program products for processing communication traffic in a router to manage quality of service in a transport network

(76) Inventor: Thomas Arnold Anschutz, Conyers, GA (US)

Correspondence Address: MYERS BIGEL SIBLEY & SAJOVEC, P.A., P.O. BOX 37428, RALEIGH, NC, 27627, US

(21) Appl. No.: 10/875,440

(22) Filed: Jun. 24, 2004

(51) Int. Cl. H04L 12/56

(52) U.S. Cl. 370/352

(57) ABSTRACT

Traffic in a communication network is processed by receiving traffic from a first network at a router. The traffic is scheduled at the router for transmission to a transport network, which supports statistical multiplexing of traffic, based on a topology of the transport network. Moreover, the router is associated with a first organization and the transport network is associated with a second organization. Congestion may be reduced in queues that support statistical multiplexing in the transport network allowing a quality of service imparted by the router to be maintained.

### FIELD OF THE INVENTION

The present invention relates to communication networks, and, more particularly, to managing Quality of Service (QoS) in communication networks.

### BACKGROUND OF THE INVENTION

The Internet is a decentralized network of computers that can communicate with one another via the Internet protocol (IP). Although the Internet has its origins in a network created by the Advanced Research Project Agency (ARPA) in the 1960's, it has only recently become a worldwide communication medium. To a large extent, the explosive growth in use and traffic over the Internet is due to the development in the early 1990's of the worldwide Web (WWW), which is one of several service facilities provided on the Internet. Other facilities include a variety of communication services such as electronic mail, telnet, Usenet newsgroups, internet relay chat (IRC), a variety of information search services such as WAIS and Archie, and a variety of information retrieval services such as FTP (file transfer protocol) and Gopher.

The WWW is a client-server based facility that includes a number of servers (computers connected to the Internet) on which Web pages or files reside, as well as clients (Web browsers), which interface the users with the Web pages. Specifically, Web browsers and software applications send a request over the WWW to a server requesting a Web page identified by a Uniform Resource Locator (URL) which notes both the server where the Web page resides and the file or files on that server which make up the Web page. The server then sends a copy of the requested file(s) to the Web browser, which in turn displays the Web page to the user.

The topology of the WWW can be described as a network of networks, with providers of network service called Network Service Providers, or NSPs. Servers that provide application-layer services as previously described may be described as Application Service Providers (ASPs). Sometimes a single service provider does both functions within a single business

In recent years, broadband access technologies, such as digital subscriber line (DSL), cable modems, asynchronous transfer mode (ATM), and frame relay have facilitated the communication of voice, video, and data over the Internet and other public and private networks. Because broadband technologies are typically deployed by a single transport service provider, like a Regional Bell Operating Company (RBOC), their Regional and Access Networks (RAN) are often shared by many NSPs and ASPs offering services that range from Internet access and VPN access to Voice over IP, Video on Demand, and Gaming. Up until recently, a given Customer Premises Network (CPN) would have been connected to a single service provider in a generic way, however a new standard for RAN service (DSL Forum TR-059) provides a RAN architecture that allows simultaneous access to multiple NSPs and ASPs and for differentiating the data transport service provided by a RAN to these service providers.

Moreover, broadband access technology has allowed service providers to expand their content and service offerings to both business and home users. For example, a user may subscribe to multiple services or applications, such as voice service, Internet access service, a video service, a gaming service, etc. from one or more service providers. These services and/or applications may be delivered over a single network connection, such as a DSL line. Unfortunately, with multiple new connectivity options and applications that require specific characteristics from the network, there is also a need to establish priorities and bandwidth allocation among multiple services and/or applications so as to customize the content delivery according to the users' and/or providers' preferences.

### SUMMARY OF THE INVENTION

According to some embodiments of the present invention, traffic in a communication network may be processed by receiving traffic from a first network at a router. The traffic is scheduled at the router for transmission to a transport network, which supports statistical multiplexing of traffic, based on a topology of the transport network. Moreover, the router is associated with a first organization and the transport network is associated with a second organization. Advantageously, congestion may be reduced in queues that support statistical multiplexing in the transport network allowing a quality of service imparted by the router to be maintained.

In other embodiments of the present invention, the first organization is a switching organization and the second organization is a transport organization.

In still other embodiments of the present invention, the first network is a regional broadband network, the router is a broadband remote access server (BRAS) and the transport network is a synchronous optical network (SONET) that supports Ethernet rings with statistical multiplexing.

In still other embodiments of the present invention, the traffic is scheduled for transmission at the router so as to provide a defined Quality of Service (QoS) for the traffic in the transport network.

In still other embodiments of the present invention, QoS comprises committed information rate (CIR), transport network resource allocation, bandwidth, and/or precedence.

In further embodiments of the present invention, the traffic is scheduled at the router among a plurality of communication queues based on the topology of the transport network. The communication queues have a plurality of priorities and/or scheduling resources associated therewith, respectively.

In still further embodiments of the present invention, the plurality of communication queues comprises queues based on Differentiated Services (Diffserv) disciplines, ATM disciplines, and/or Ethernet disciplines.

Other systems, methods, and/or computer program products according to embodiments of the invention will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Other features of the present invention will be more readily understood from the following detailed description of specific embodiments thereof when read in conjunction with the accompanying drawings, in which:

FIG. 1 is a block diagram that illustrates a communication network in accordance with some embodiments of the present invention; and

FIG. 2 is a flowchart that illustrates operations for using a router to manage Quality of Service (QoS) in a transport network in accordance with some embodiments of the present invention.

### DETAILED DESCRIPTION OF EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures. As used herein, the term “and/or” includes any and all combinations of one or more of the associated listed items.

The present invention may be embodied as systems, methods, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention are described herein in the context of managing quality of service (QoS). As used herein, QoS includes, but is not limited to, treatment applied to an access session, data flow, and/or packet with respect to scheduling a resource, bandwidth allocation, and/or delivery target in an individual element or across an end-to-end system.

Embodiments of the present invention are also described herein in the context of processing a packet. It will be understood that the term “packet” means a unit of information and/or a block of data that may be transmitted electronically as a whole or via segments from one device to another. Accordingly, as used herein, the term “packet” may encompass such terms of art as “cell,” “frame,” and/or “message,” which may also be used to refer to a unit of transmission.

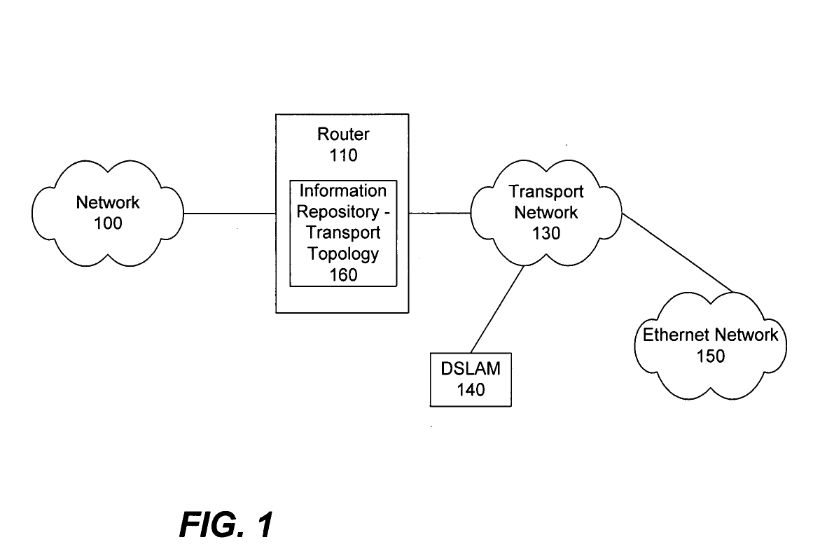

Referring now to FIG. 1, a communication network, in accordance with some embodiments of the present invention, comprises a network 100, which may be a regional broadband network that is communicatively coupled to a router 110, which may be a broadband remote access server (BRAS). The router 110 is communicatively coupled to a transport network 130, which may be any network that supports statistical multiplexing of communication traffic, such as, for example, an ATM network, a multi-service provisioning platform (MSPP) synchronous optical network (SONET) system, or other type of network that supports statistical multiplexing. The transport network 130 is communicatively coupled to one or more digital subscriber line access multiplexer (DSLAMs) 140 and an Ethernet network 150. It will be understood, however, the DSLAM 140 and Ethernet network 150 are examples for purposes of illustrating some embodiments of the present invention. The transport network 130 may be communicatively coupled to various other types of networks, transmission devices, and the like in accordance with various embodiments of the present invention.

The primary function of the network 100 and the router 110 is to provide end-to-end data transport between the customer premises and a network service provider (NSP) or application service provider (ASP). A NSP is defined as a service provider that requires extending a service provider-specific Internet Protocol (IP) address. The NSP owns and procures addresses that they, in turn, allocate individually or in blocks to their subscribers. The subscribers are typically located in customer premises networks (CPNs). The NSP service may be subscriber-specific or communal when an address is shared using Network Address Port Translation (NAPT) throughout a CPN. An ASP is defined as a service provider that uses a common network infrastructure provided by the network 100 and an IP address assigned and managed by the network 100 provider. This is a new type of DSL service. The network 100 provider owns and procures addresses that they, in turn, allocate to the subscribers. ASPs then use this common infrastructure to provide application or network services to those subscribers. For example, an ASP may offer gaming, video on demand, and/or access to VPNs via IPsec or some other IP-tunneling method. The ASP service may be subscriber-specific or communal when an address is shared using NAPT throughout a CPN.

The router 110 performs multiple functions in the communication network. The router's 110 most basic function is to provide aggregation capabilities between the network 100 and the NSP/ASP. For aggregating traffic, the router 110 serves as a L2TP Access Concentrator (LAC), tunneling multiple subscriber Point-to-Point Protocol (PPP) sessions directly to an NSP or switched through a L2TS. The router 110 may also perform aggregation for terminated PPP sessions or routed IP sessions by placing them into IP VPNs. The router 110 may also supports ATM termination and aggregation functions.

Beyond aggregation, the router 110 may also be an injection point for providing policy management and IP QoS in the network 100. The router 110 may support the concept of many-to-many access sessions. Policy information can be applied to terminated and non-terminated sessions. For example, a bandwidth policy may be applied to a subscriber whose Point-to-Point (PPP) session is aggregated into an L2TP tunnel and is not terminated by the router 110. Sessions that terminate on (or are routed through) the router 110, however, can receive per flow treatment because the router 110 has IP level awareness of the session. In this model, both the aggregate bandwidth for a customer as well as the bandwidth and treatment of traffic per-application can be controlled.

Moreover, in accordance with some embodiments of the present invention, the router 110 may be used to manage QoS in the transport network 130. Aspects of QoS in the transport network 130 that may be managed by the router 110 include, but are not limited to, committed information rates (CIRs), transport network 130 resource allocation, bandwidth, and/or precedence of communication traffic. In accordance with some embodiments of the present invention, the router may be associated with one organization and the transport network may be associated with another organization. For example, the router may be associated with a switching organization while the transport network may be associated with a transport organization. Conventionally, the provider of the transport network 130 would have to manage the QoS rules from the Ethernet network 150 and/or the DSL network 140 so that various information rates, bandwidths resource allocations, delays, etc. would be supported. Because two different organizations, e.g., a switching organization and a transport organization, are responsible for managing the overall network, the statistical multiplexing capabilities of the transport network 130 may go unused because it is difficult to manage the devices in the transport network 130 via two separate organizations. Advantageously, the router 110, in accordance with some embodiments of the present invention, may manage traffic flowing downstream into the transport network 130 to reduce congestion in the transport network queues so that QoS commitments may be met thus allowing the QoS and/or CIR in the network to be managed by a single organization or entity.

According to some embodiments of the present invention, the router 110 may be provided with access to an information repository 160 containing the topology of the transport network 130. The information repository 160 may be stored locally at the router 110 and/or may be stored remotely from the router 110 and accessed through one or more communication links via, for example, a network.

The router 110 may further include multiple communication queues that may be used to schedule traffic for transmission to the transport network 130, in accordance with some embodiments of the present invention. These queues may be based on Differentiated Services (Diffserv) disciplines, ATM disciplines, and/or Ethernet disciplines in accordance with various embodiments of the present invention. For example, the router 110 may include five transmission queues: one expedited forwarding (EF) queue, up to 3 assured forwarding (AF) queues, and one best effort (BE) queue. Diffserv like treatment is assumed when describing the queue behaviors. The EF queue typically receives the highest priority and is typically served first. This queue type is defined for constant bit rate type servers. A rate limit may be associated with this queue. AF queues are defined for traffic that is more variable in nature and would be inefficient to associate with a fixed amount of network resources. Queues in this category could receive different levels of priority or could simply be used as an aggregate priority, but each queue may have a different rate limit applied depending on the requirements of the application using that queue. A BE queue is the default queue and has resources available to it only after packets that are in profile for the EF and AF queue are served.

Although FIG. 1 illustrates an exemplary communication network, it will be understood that the present invention is not limited to such configurations, but is intended to encompass any configuration capable of carrying out the operations described herein. It will be appreciated that, in accordance with some embodiments of the present invention, the functionality of the router 110 may be implemented using discrete hardware components, one or more application specific integrated circuits (ASICs), a programmed digital signal processor or microcontroller, a program stored in a memory and executed by a processor, and/or combinations thereof. In this regard, computer program code for carrying out operations of the router 110 may be written in a high-level programming language, such as C or C++, for development convenience. In addition, computer program code for carrying out operations of the present invention may also be written in other programming languages, such as, but not limited to, interpreted languages. Some modules or routines may be written in assembly language or even micro-code to enhance performance and/or memory usage.

The present invention is described hereinafter with reference to flowchart and/or block diagram illustrations of methods, systems, and computer program products in accordance with exemplary embodiments of the invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

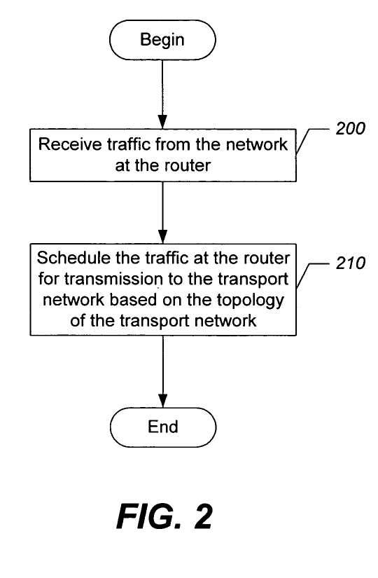

Operations for using a router to manage QoS in a transport network, in accordance with some embodiments of the present invention, will now be described with references to FIGS. 2 and 1. Referring now to FIG. 2, operations begin at block 200 where the router 110 receives traffic from the network 100. The router 110 schedules the traffic for transmission to the transport network 130 based on the topology of the transport network, which information is contained in the information repository 160 at block 210. In accordance with some embodiments of the present invention, the router 110 may use the transport network 130 topology information stored in the information repository 160 to schedule the traffic for transmission to the transport network 130 by scheduling the traffic among a plurality of communication queues as described above. Thus, by scheduling the traffic at the router 110 for transmission to the transport network 130 based on the topology of the transport network 130, the router 110 may allow a defined QoS to be provided for the traffic in the transport network 130. That is, the router 110 may extend QoS management into the transport network 130, which would otherwise have no QoS management capabilities or these capabilities would have to be provided by the transport network 130 provider. In this way, embodiments of the present invention may separate QoS management in the transport network 130 from the statistical multiplexing fabric of the transport network 130. This also allows organizational separation of the management entities between transport gear that supports statistical multiplexing of traffic and switching gear that controls QoS in a network.

The flowchart of FIG. 2 illustrates the architecture, functionality, and operations of some embodiments of methods, systems, and computer program products for using a router to manage QoS in a transport network. In this regard, each block represents a module, segment, or portion of code, which comprises one or more executable instructions for implementing the specified logical function(s). It should also be noted that in other implementations, the function(s) noted in the blocks may occur out of the order noted in FIG. 2. For example, two blocks shown in succession may, in fact, be executed substantially concurrently or the blocks may sometimes be executed in the reverse order, depending on the functionality involved.

Many variations and modifications can be made to the embodiments described herein without substantially departing from the principles of the present invention. All such variations and modifications are intended to be included herein within the scope of the present invention, as set forth in the following claims.

1. A method of processing communication traffic, comprising:
receiving traffic from a first network at a router; and
scheduling the traffic at the router for transmission to a transport network, which supports statistical multiplexing of traffic, based on a topology of the transport network, wherein the router is associated with a first organization and the transport network is associated with a second organization.

2. The method of claim 1, wherein the first organization is a switching organization and the second organization is a transport organization.

3. The method of claim 1, wherein the first network is a regional broadband network, the router is a broadband remote access server (BRAS) and the transport network is a synchronous optical network (SONET) that supports Ethernet rings with statistical multiplexing.

4. The method of claim 1, wherein scheduling the traffic at the router further comprises:
scheduling the traffic at the router for transmission to the transport network so as to provide a defined Quality of Service (QoS) for the traffic in the transport network.

5. The method of claim 4, wherein the QoS comprises committed information rate (CIR), transport network resource allocation, bandwidth, and/or precedence.

6. The method of claim 1, wherein scheduling the traffic at the router further comprises:
scheduling the traffic at the router among a plurality of communication queues based on the topology of the transport network, the communication queues having a plurality of priorities and/or scheduling resources associated therewith, respectively.

7. The method of claim 6, wherein the plurality of communication queues comprises queues based on Differentiated Services (Diffserv) disciplines, ATM disciplines, and/or Ethernet disciplines.

8. A system for processing communication traffic, comprising:
means for receiving traffic from a first network at a router; and
means for scheduling the traffic at the router for transmission to a transport network, which supports statistical multiplexing of traffic, based on a topology of the transport network, wherein the router is associated with a first organization and the transport network is associated with a second organization.

9. The system of claim 8, wherein the first organization is a switching organization and the second organization is a transport organization.

10. The system of claim 8, wherein the first network is a regional broadband network, the router is a broadband remote access server (BRAS) and the transport network is a synchronous optical network (SONET) that supports Ethernet rings with statistical multiplexing.

11. The system of claim 8, wherein the means for scheduling the traffic at the router further comprises:
means for scheduling the traffic at the router for transmission to the transport network so as to provide a defined Quality of Service (QoS) for the traffic in the transport network.

12. The system of claim 11, wherein the QoS comprises committed information rate (CIR), transport network resource allocation, bandwidth, and/or precedence.

13. The system of claim 8, wherein the means for scheduling the traffic at the router further comprises:
means for scheduling the traffic at the router among a plurality of communication queues based on the topology of the transport network, the communication queues having a plurality of priorities and/or scheduling resources associated therewith, respectively.

14. The system of claim 13, wherein the plurality of communication queues comprises queues based on Differentiated Services (Diffserv) disciplines, ATM disciplines, and/or Ethernet disciplines.

15. A computer program product for processing communication traffic, comprising:
a computer readable storage medium having computer readable program code embodied therein, the computer readable program code comprising:
computer readable program code configured to receive traffic from a first network at a router; and
computer readable program code configured to schedule the traffic at the router for transmission to a transport network, which supports statistical multiplexing of traffic, based on a topology of the transport network, wherein the router is associated with a first organization and the transport network is associated with a second organization.

16. The computer program product of claim 15, wherein the first organization is a switching organization and the second organization is a transport organization.

17. The computer program product of claim 15, wherein the first network is a regional broadband network, the router is a broadband remote access server (BRAS) and the transport network is a synchronous optical network (SONET) that supports Ethernet rings with statistical multiplexing.

18. The computer program product of claim 15, wherein the computer readable program code configured to schedule the traffic at the router further comprises:
computer readable program code configured to schedule the traffic at the router for transmission to the transport network so as to provide a defined Quality of Service (QoS) for the traffic in the transport network.

19. The computer program product of claim 18, wherein the QoS comprises committed information rate (CIR), transport network resource allocation, bandwidth, and/or precedence.

20. The computer program product of claim 15, wherein the computer readable program code configured to schedule the traffic at the router further comprises:
computer readable program code configured to schedule the traffic at the router among a plurality of communication queues based on the topology of the transport network, the communication queues having a plurality of priorities and/or scheduling resources associated therewith, respectively.

21. The computer program product of claim 20, wherein the plurality of communication queues comprises queues based on Differentiated Services (Diffserv) disciplines, ATM disciplines, and/or Ethernet disciplines.

22. A communication network, comprising:
a first network;
a transport network that supports statistical multiplexing of traffic; and
a router that is configured to receive traffic from the first network and to schedule the traffic for transmission to the transport network based on a topology of the transport network, wherein the router is associated with a first organization and the transport network is associated with a second organization.

23. The communication network of claim 22, wherein the first organization is a switching organization and the second organization is a transport organization.

24. The communication network of claim 22, wherein the first network is a regional broadband network, the router is a broadband remote access server (BRAS) and the transport network is a synchronous optical network (SONET) that supports Ethernet rings with statistical multiplexing.

25. The communication network of claim 22, wherein the router is further configured to schedule the traffic for transmission to the transport network so as to provide a defined Quality of Service (QoS) for the traffic in the transport network.

26. The communication network of claim 25, wherein the QoS comprises committed information rate (CIR), transport network resource allocation, bandwidth, and/or precedence.

27. The communication network of claim 22, wherein the router is further configured to schedule the traffic among a plurality of communication queues based on the topology of the transport network, the communication queues having a plurality of priorities and/or scheduling resources associated therewith, respectively.

28. The communication network of claim 27, wherein the plurality of communication queues comprises queues based on Differentiated Services (Diffserv) disciplines, ATM disciplines, and/or Ethernet disciplines.
